(19) United States
(12) Patent Application Publication
(10) Pub. No.: US 2011/0080303 A1
(43) Pub. Date: Apr. 7, 2011

(54) COMPUTERIZED TRAFFIC SIGNAL SYSTEM

(76) Inventors: Allen GOLDBERG, Piermont, NY (US); Robert Craig, Wyckoff, NJ (US)

(21) Appl. No.: 12/873,833

(22) Filed: Sep. 1, 2010

Related U.S. Application Data
(60) Provisional application No. 61/238,850, filed on Sep. 1, 2009.

(51) Int. Cl. G08G 1/07; H04N 7/18

(52) U.S. Cl. 340/909; 348/149; 348/E07.085

(57) ABSTRACT

Traffic through a portion of a city formed of streets defining a grid includes clusters of traffic signs, each cluster being positioned at an intersection and having its own cluster process controller. The clusters also include cameras monitoring traffic through and at each intersection. The cameras provide information used locally or at remote localities to control traffic. The remote localities may include a traffic command center, fire/police stations or a home security office.

### RELATED APPLICATIONS

This application claims priority to U.S. provisional application Ser. No. 61/238,850 filed on Sep. 1, 2009 and incorporated herein by reference.

### BACKGROUND OF THE INVENTION

A. Field of Invention

This invention pertains to an improved traffic signal system in which at each intersection, the lights are controlled by microprocessors. The microprocessors are communicating with each other and/or a command center to insure a smooth traffic flow and to accommodate the movement of emergency vehicles.

B. Description of the Prior Art

At the end of the nineteenth century, the city streets were becoming increasingly congested with vehicular traffic which led to increased motorist confusion at intersections. The streets were getting more and more dangerous. The increased frequency and severity of automobile accidents created hardship on motorists and individuals alike. According to one anecdote, in 1910 there were only two automobile operated in Kansas City, Ks., but somehow their drivers managed to collide!

Traffic signals were invented to solve this problem. The first traffic signals were mere electrically operating arms and were probably adapted from railroad signals. Traffic signals with lights came in use of after 1912. These devices could be used to guide and control the vehicular and pedestrian movement through intersections.

The first traffic signal with lights consisted of a red and green lights set on a pole to indicate the direction of traffic within the intersection and alternately restricted and allowed the flow from the various sides of the intersection. The yellow light was added to provide a delay between the red and the green to provide the on-going traffic flow to clear the intersection. The signal lights were controlled by a simple mechanical controller that relied on an electrical timer with appropriate open and close point contacts.

For many years this simple device effectively controlled traffic flows in most intersections all over the world.

The number of motorists grew exponentially through the twenty century, placing more demands on the roadways and highway infrastructure to stay pace with their needs. As the number of motorists and motor vehicles increased, the standard traffic light systems were no longer adequate. Additional controls had to be added and automated for more effective and safer traffic control. T However, the resulting traffic control and highway infrastructure remains outdated and technically inferior. As a result, instead of solving traffic congestion, the existing archaic traffic light systems contribute to the traffic congestion. The highways are overcrowded, the roadways and bridges are failing, gasoline and fuel have become cost prohibitive for businesses and Individuals. This has led to hardship on businesses and individuals who suffer from increased costs to operate their lives and burden their productivity.

In other words, advancements in traffic signal technology have been limited. Instead of rethinking traffic signal systems, the old systems were only slightly modified. The traffic signal systems that exist today are not capable of keeping up with the needs of the society due to over congested roadways and the need for information collection and distribution required for the nations home land security. Intersection information and sign information will be is required to operate an intelligent transportation system that will benefit society.

In the late Twentieth century the new information age started. Miniaturized electronic processor systems became available having enormously improved data processing and storage data capabilities. There seems to be no limit in the capacity of how processors can be used to benefit our lives. The world is becoming more urbanized and the creation of the megalopolis the populations are growing closer and more congested. Commuters are facing longer commutes by car, bus or train. The use of central and local control must be readdressed to decrease highway congestion.

The present signal systems cause slowdowns because of an overabundance of individual, autonomously and asynchronously operating signal. There is a need for a traffic signal system that is more intelligent and more autonomous than present systems. Moreover, there is a need for more central control with the capability of being able to send and receive information in real time. There is a need for automate processors to decipher and interpret information received at the intersection and initiate responses based on the information received.

Traffic signal systems must also be designed that meet the new requirements imposed by new laws for green, environmentally friendly infrastructure. The improved system must be cheaper and use less energy.

A further concern is that traffic signals must be cheap, easy to maintain, yet they must be properly spaced from new high voltage lines. Current carrying materials and power sources are costing more each day, limiting the building of more signals. The expansions of city dwellers are on the increase. No more streets or roads can be built without uprooting homeowners and business.

Physically, a typical traffic signal system that exists today can have a combination of cable strain poles and mast arm poles as the primary support for signal heads and traffic signs. As discussed, the controllers vary from mechanical, automatic, semi-automatic, and fully automatic controller units. Intersections using mechanical devices are archaic and can only work locally with no control other than a timer or clock. Intersections relying on controllers that are semiautomatic or actuated devices must rely on local devices, whether they use traffic loops, micro-detectors or intersection video detection cameras still have a limited local operation.

Frequently, in a given area, many intersections are hard wired so that they are coordinated with each other. In more modern systems, the hardwired connection can be replaced with radio waves, wireless transmitters and receivers, and fiber optic cable. The same means may also be used to connect signals to a central control system. However, the ability to communicate is less than perfect—the time it takes to transmit and receive information and command is slow by today's standards. The information received must be deciphered and interpreted by human intervention at a central control site before centrally-requested tasks can be performed. This infrastructure is delaying the response time to action items. In some cases, rapid response to actions items could be life saving during an event of national security or natural disaster.

The global community of business and individuals needs a process invention to bring together the centralization of highway information. The present invention provides a system with traffic signals and intersections that operate simply and limit the amount of human intervention required to run the system.

### SUMMARY OF THE INVENTION

The improved traffic system described herein can bring transportation and signal intersections into the new information age. By retrofitting and building new intersections, we can eliminate, or at least reduce, the previously described problems.

The simple intersection consists of four corners with one or two lanes in each direction. Before we get into more complex applications it is easier to explain the most elementary design. The invention process starts with four mast arm poles and four camera poles. The new traffic Signs (TMS) are mounted to the mast arms so that they will face the four direction of oncoming traffic, each further carrying CCTV type video cameras. The four cameras will be located back from the mast arms at each approach to the intersection. The cameras will be able to provide real-time feedback to the traffic management center computer to alert of accidents, or emergency situations. The excavation of mast foundations and placement of conduit will be lessened by using hollow masts. Fiber optic cabling may be used as a means of interconnect the signals between for local and central locations.

New control boxes are used as a local an information and control center that will be able to perform many functions based on commands from a central location as well as other information. These functions can range from traffic signaling, detour guiding, home land defense information. The signs will be matrix designed panels capable of displaying text and images which will able the intersection to operate with a much higher awareness and allow faster movement through intersections. Pedestrian and driver's confidence and comfort level will be higher due to the increased information relayed to the both. This will result in less accidents and ability to maintained speed to allow more movement and less congestion where bottlenecks can occur.

The new controller is provided with software allows the central control center computer to receive and manipulate the information received from the equipment in the intersection and effectuate solution autonomously. Any situation that is deem by the computer to by other that normally occurring will be analyzed and will be automatically corrected by the central computer without the interaction of the operator at the station. A Bypass manual command will be designed into the system which will allow Homeland Security personnel to operate the system during time of emergency at the local or worldwide level. Hardware and software can easily be part of planning and design as a new traffic management center. The software program will have the following functions written in its memory: control tech, dynastic tech, remote operating tech, and override command tech. The software will have automatic operating tasking. The information that will be received from the local field locations will be and the software will be able to send commands back to the local traffic signal locations that will be given will be fully automated by its program.

The control boxes will be provided with hardware that is preferably rack mounted for easy installation and space saving application. Rack mounting is available for the additional hardware. The local traffic signal controller is an integral part of one of the TMS signals and information station module. The controller is operating using software that commands the other TMS signs within the intersection and cooperates with other controllers for other intersections. The system further includes CCTV cameras, microwave processors, and transmitter/receiver devises, that send and receive orders automatically commanded from the program central TMC software. The information can be passed between the local and central control devised using a satellite communications, microwave towers, T-1 lines, control offices, and already installed high speed fiber optic cables.

Preferably, the power source for the local systems for a cluster controlling a given intersection is a low voltage 12 Volt DC source that optionally includes or is energized line voltage and/or a system of solar panels and batteries for nighttime operations. The solar panels and battery cabinets are preferably mounted on the mast arms.

One of the advantages for this invention is that is solves the problem regarding the placement traffic signal equipment within proximity of power arms and high voltage lines, cable TV, telephone, high speed data lines. The new installation will not interfere with the mentioned facilities. The new mast arms or poles can be designed shorter than that of the current equipment can allow. The TMS is mounted directly on the mast arm and only require road clearance of 16-6″. The signal arms can be smaller, lighter, and safer by not having to withstand wind loads of heavier components attached to a conventional intersection of today.

The interconnection of the display equipment, camera equipment, and pedestrian arms can be accomplished smaller underground facilities. The majority of command operations will be sent through a fiber optic cable for sending and receiving command signals. Fiber optic cable is a good choice for this function for its small size, high speed data transfer, and the elimination of “cross talking”—the compromising of data due to electrical interference.

Preferably, the control box and all the other equipment of the system is powered by a an uninterruptable power source that operate the system with reduced system operating amperage requirements and preferably incorporates one or more appropriately sized solar panels. The new TMS system has micro-components that use less power to operate and command the multi functional system. Environment consciousness is required in the world today to make it possible for the megalopolises to have intersection safety, an informational center, and adapt to the existing roads that choke our cities.

When this project was conceived, the need for a new process was thought out to operate an information system that could control the intersections moving traffic efficiently. The present systems both present and future demands quicker response times and information to control the emergency and day-to-day operation. Systems controllers and people are to be brought into the necessity caused by congestion. The demands on the cities and emergency situations that are caused by fire, terrorism, movement of traffic during peak time and regular time, and directional information for many actions.

The present systems still use the slow flow of information. This is how the information is being processed, the traffic signal installation and its actuation is either local programmed or a combination of local and centralized command controlled. This limits how the information can be changed or processed. At present the information is stopped and need the involvement of tech. personal to help annualized the information that has been data generated. We must change this delay.

Many areas throughout the world are being operated by fiefdom control and not sharing with others causing a non-compatibility of components to share and incorporate a worldwide traffic command central system. Remember the Human factor. The Human mind can create software but can only operate a complex system at a slow pace.

### BRIEF DESCRIPTION OF THE FIGURES

FIG. 1 shows a typical intersection with four traffic signals, one at each corner, that is part if the system constructed in accordance with this invention;

FIG. 2 shows an elevational view of a typical intersection with two signals constructed in accordance with this invention taken along line 2-2;

FIGS. 2A-2C show elevational views of street corners with other configurations of traffic signals and/or cameras;

FIG. 3 shows a plurality of city streets arranged in a typical grid with traffic signals at each intersection controlled by a complex control structure constructed in accordance with this invention;

FIG. 4 shows a block diagram of a traffic signal cluster control subsystem;

FIG. 4A shows a block diagram of an alternate embodiment of the invention;

FIGS. 5-7 show flow charts for various modes of operation for the cluster of FIGS. 1-4;

FIG. 8 shows an isometric view of one embodiment of the main traffic signal;

FIG. 8A shows an elevational view of the front support for the traffic signal of FIG. 8;

FIG. 8B shows an elevational view of the back support for the traffic signal of FIG. 8;

FIG. 8C shows an elevational view of the traffic signal itself;

FIGS. 8D and 8E show side views of the traffic signal support;

FIG. 9 shows the display of FIG. 8 with protective panels;

FIGS. 10A-10F shows various configurations or images for the display;

FIG. 11 shows diagrammatically details of a display using fiber optics;

FIG. 12 shows a fuel cell for powering a traffic signal; and

FIG. 13 shows a traffic signal incorporating the fuel cell.

### DETAILED DESCRIPTION

The improved traffic system described herein can bring transportation and signal intersections into the new information age. By retrofitting and building new intersections, we can eliminate, or at least reduce, the previously described problems.

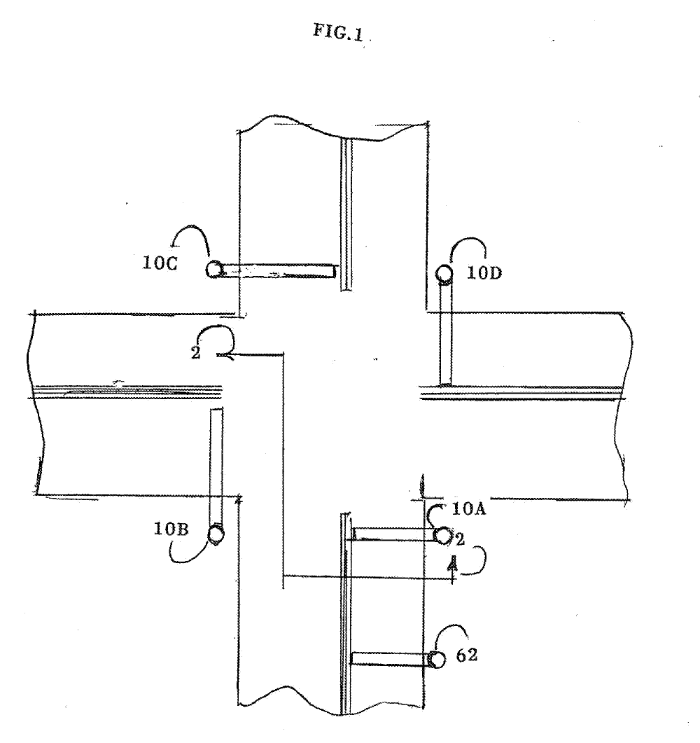

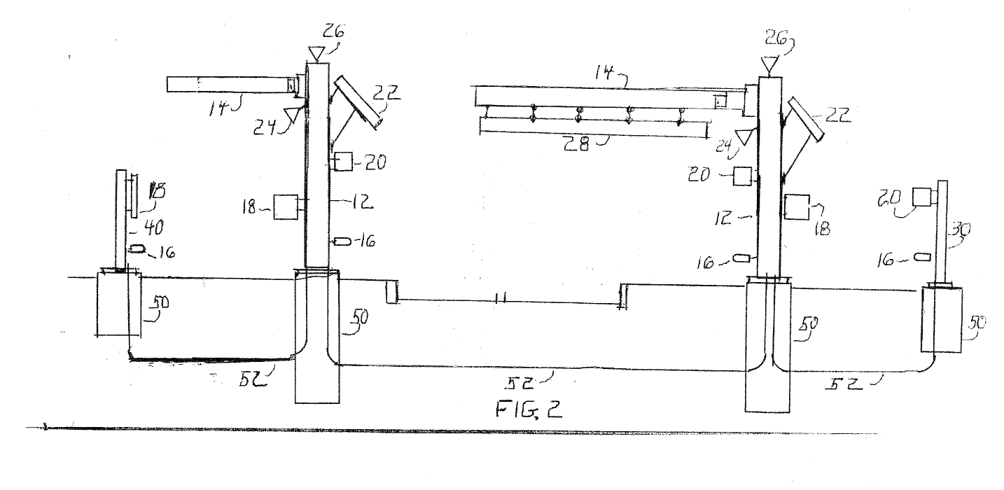

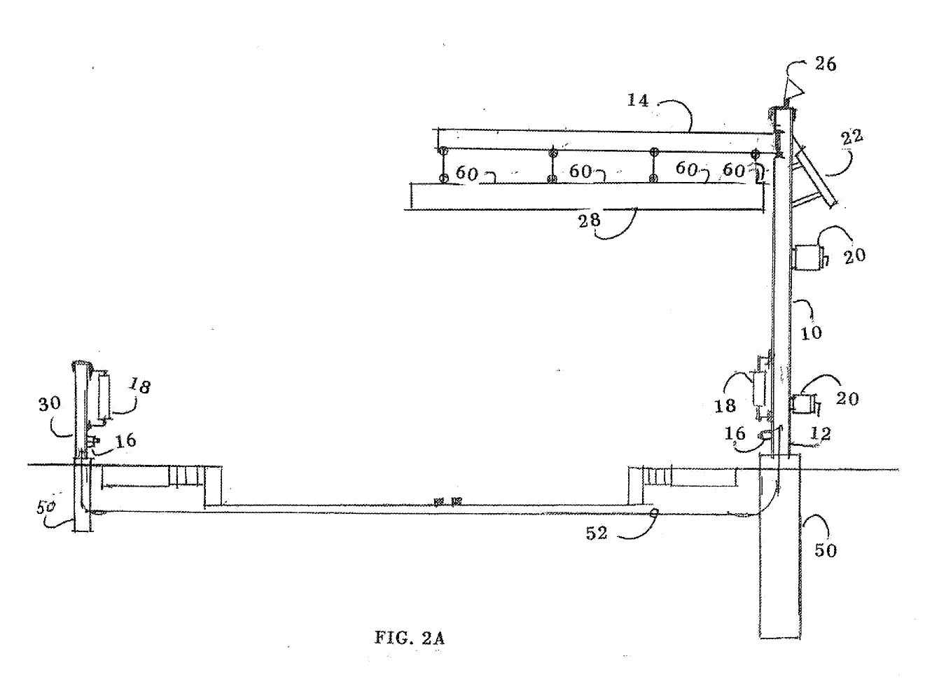

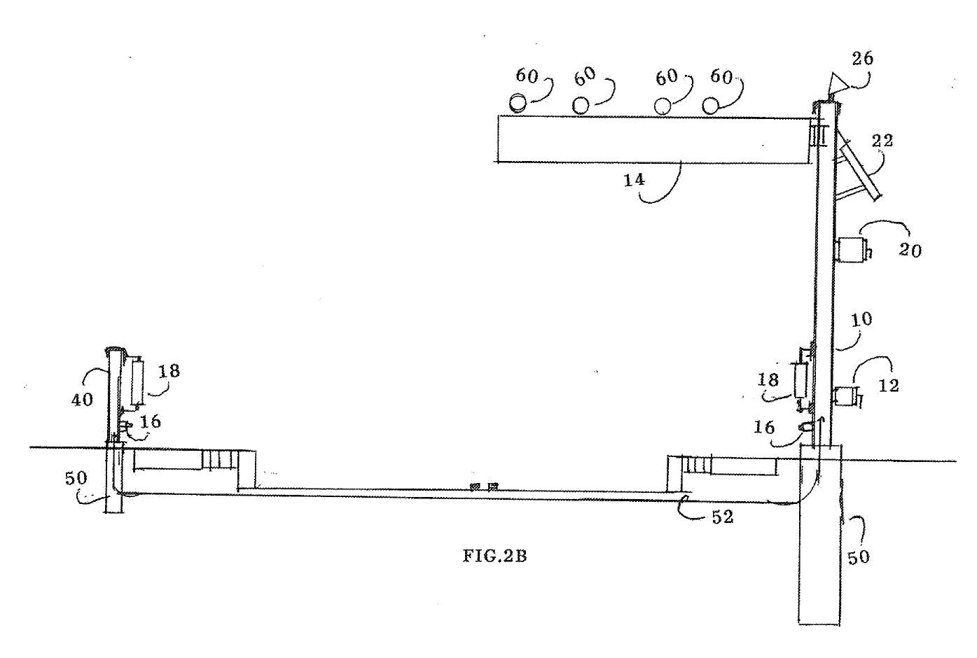

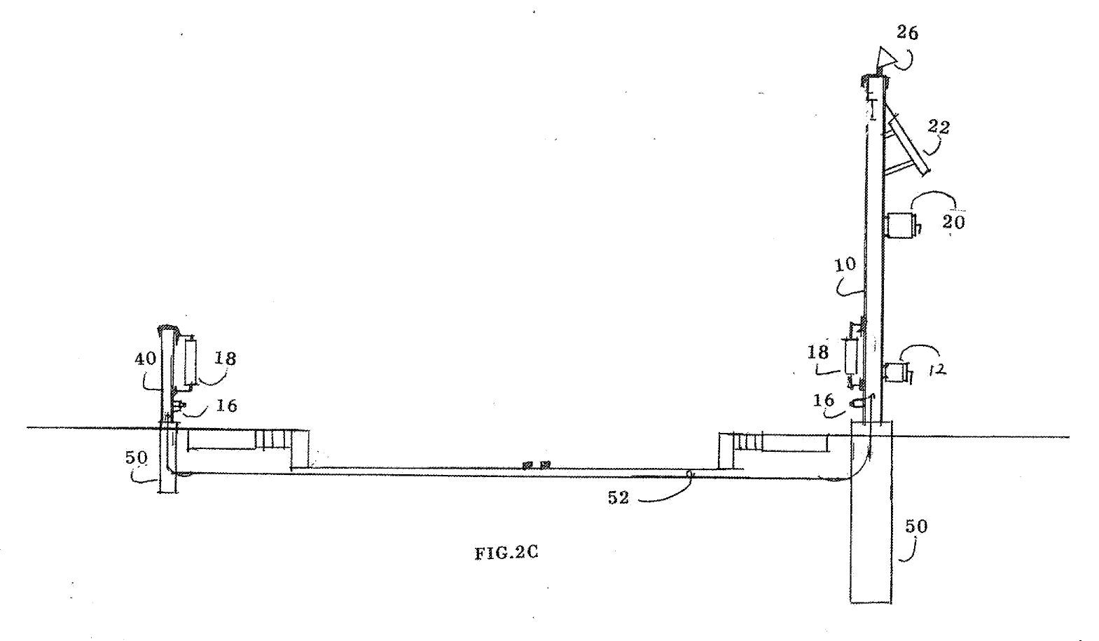

The simple intersection, illustrated in FIGS. 1 and 2 consists of four corners with one or two lanes going in each direction. Before we get into more complex applications it is easier to explain the most elementary design. In FIG. 1, a lane traffic signal 10A, 10B, 10C, 10D is provided at each of the intersection. The signals at a given intersection are referred to herein as a signal cluster 10.

As seen FIG. 2, each traffic signal 10A, 10B includes a vertical mast 12 supporting a horizontal arm 14 in a cantilevered manner. (It should be understand that cables and other conventional means may be used to support the arms on the mast. These known elements have been omitted for the sake of clarity). Attached to mast there are provided several additional components of the system, including a pushbutton 16 (activated by a pedestrian when he wants to cross the intersection, different pushbuttons being provided for crossing in different directions, as required); a local control box 18 containing electronic circuitry for the various components; a pedestrian signal 20, a solar panel 22, a camera 24; one or more RF antennas 26, etc, Attached to the horizontal arm 14 is an elongated traffic sign 28 discussed in more detail below. It should be understood that not all the components listed above may be provided for every traffic signal 10.

In some instances, a separate traffic signal 30 is provided for pedestrian use only, which traffic signal 30 includes a mast 32, a pushbutton 16, a pedestrian signal 20, etc. In other instances, a mast 40 may be provided for supporting another control box 18.

The various must are imbedded in cement foundations 50 or otherwise secured. The various masts and their components are interconnected by metallic wires and/or optical cables in conduits 52. The excavation of arm foundations and placement of conduit will be lessened by using masts that are hollow in them idle so that they can accommodate the communication means. Wires, fiber optic cables or wireless communication channels are used to communicate with the command center as well.

FIG. 2A is similar to FIG. 2 but it shows a retrofitted street corner with the traffic signal 28 being attached to an existing pole 14. As shown in FIG. 2A, in one embodiment on each arm or pole 14 four video cameras 60 are also provided for monitoring traffic, as described below (these cameras have been omitted from FIG. 2 for the sake of clarity). FIG. 2B shows an elevational view of a display 28 with cameras 60.

In an alternate embodiment, a separate mast and arm are provided at some or all the intersections for supporting just the cameras, as shown in FIG. 2C.

These separate mast/arm assemblies, such as the assembly 62 in FIG. 1 are set back by 10-20 ft from the respective intersection. The cameras 24, 60 provide real-time feedback to the traffic management center computer of accidents, emergency situations, etc., as discussed in more detail below.

Control box 18 provides the signals each traffic signal with information from the command center and are configured to perform many functions based on commands as well as other information. These functions can range from traffic signaling, detour guiding, home land defense information as described more fully below.

The traffic signs 28 are matrix-type display panels using LEDs or similar technologies. Displays of this known are well known and used on large outboard advertising boards. The displays have their own control circuitry and are configured to text and images to operate with a much higher awareness and allow faster movement through intersections. Pedestrian and driver's confidence and comfort level will be higher due to the increased information relayed to the both. This will result in less accidents and ability to maintained speed to allow more movement and less congestion where bottlenecks can occur.

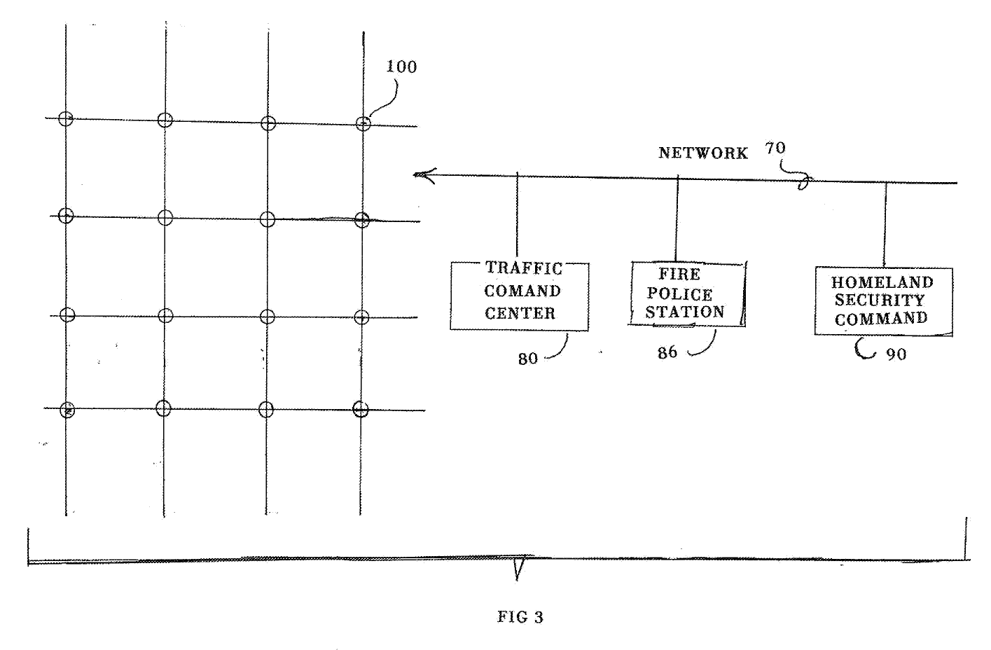

FIG. 3 shows traffic on a plurality of streets arranged in section of a city, the streets being arranged in a typical city grid 100. At each intersection there is a plurality of traffic signals 10 as described above. The control boxes 18 of the signals are connected through a network 70 to several centers including a traffic command center 80, one or more fire and police stations 86, a home security command center 90, and other similar agencies having the need to either control or at least monitor the traffic within the grid 100. The network 70 may be based on wired, wireless, microwave, satellite, or other communication systems or combinations of such systems.

Hardware/Software

The control box 18 receives various inputs, including, for example, inputs from the cameras disposed at the intersection and will operate on this information using analyzes the site camera's information or the programmed procedure placed into its memory to change and place new direction commands through its own processors, without the need for delay time taken by an operator to make a decision where to change and broadcast the new change up before anything can be accomplished.

A software program running on the hardware operates at nanosecond response, using its diagnostic program of what programmed options it can make changes and give inform the public will need to keep the intersection open, to flow traffic. (In this application, the term diagnostic program refers to a program that not only monitors the elements of the system for malfunctions but also monitors the inputs from the cameras and various other devices associated with the system and interrupts the normal operation of the system if necessary to service these devices and/or take other action as required, as described more fully below).

The software program is designed with the basic commands for each intersection, and include a typography layout, a timing program; informational sign download for the entire system with the default instructions for one intersection more intersections in the system, if necessary, the software detours traffic or personal, when an emergency occurs.

The software also controls the symbols, images and texts on the traffic signal 28. The instant response of this display insures optimal traffic flow without the driver or pedestrian having any down time to delay their next move.

When an accident occurs, the cameras at the intersection provide the information to the software to analyze the situation.

The software adjusts the operation of the traffic signal at the intersection and, if necessary, at neighborhood intersections to allow detouring procedure that will keep the traffic moving as first response reaction. The software also contacts the 911 emergency services and dispatch information necessary to report to the area that has the problem. The program software will have in its memory the necessary data for any response situation.

The software will control the responders and intersection displays to keep the intersection open and keep traffic moving. The biggest problem is responders clogging an intersection with too many pieces of equipment and close useable lanes. The present system will know what response equipment and personal is needed for the first response.

The software will be programmed for evacuation routes from disaster areas to safe areas. Almost any congested areas at present cannot evacuate because of gridlock. Our software will control intersections by giving priority phasing green light passage. The side phases will show detour information, and where to enter the evacuation routes. The software will do this move automatically as first response.

The software with its programming will operate 24/7 and diagnose its program instantly to correct any mal function, and give driving information, control flow at intersections, control detours, set parameters for responders personal and equipment, and homeland security evacuation information/routes. The program will have the capability of assigning necessary manpower and equipment for first response.

The software will have defaults, overrides, recordable data, a uniform design, and have worldwide capabilities as a master traffic command control system that Home Land Security in any country in the world.

As discussed above, a traffic signal system in accordance with this invention includes a signal cluster disposed at each intersection. This signal cluster controls the traffic at the intersection. Depending on the time of the day, the day of the week, general traffic conditions, the weather and many other factors, the cluster can operate in an independent and asynchronous mode in which it is completely oblivious to other clusters in the area, or in a semi-synchronous mode in which the timing of the states of at the intersection is somewhat related to other clusters, or a completely synchronous mode in which a plurality of clusters cooperate to expedite traffic movement through the respective geographic region. A plurality of clusters is sometimes termed in the application as a matrix, however it should be understood that a matrix does not necessary mean an array of rectangular clusters arranged in rows and columns.

More particularly, as shown in FIG. 4, the traffic signs and functions of each cluster are controlled and monitored by a microprocessor-based subsystem 200 disposed in one or more of the control boxes 18. The heart of the subsystem is a cluster process controller 202. This controller 202 receives and/or sends information to the pedestrial signal 20, display 28, as well as a video analytics and storage processor 204 (which controls the content shown on display 28), a network switcher 206 used for switching the cameras to the microprocessor. All these components are coupled to the controller 202 through an appropriate interface 208. The controller 202 is also connected to the network 70 through an appropriate communication device 210.

Alternatively, the various components are interconnected through a local wired or wireless network. The program running the microprocessor 202 is provided in a ROM or removable flash card 212. Flash cards 212 provide more flexibility since the programming could be changed easily by simply swapping the flashcards.

Power is provided by a UPS/battery component 214 that can be incorporated into one of the control boxes 18 or can be provided in a separate cabinet disposed near the cluster 10. Finally, especially for remote area, additional or alternate energy may be provided by a solar panel 216. Finally, the controller 202 can be provided with a standard input port (not shown) for connection to a local, portable device such as a portable laptop 218 that may be used by a technician for trouble shooting, reprogramming, etc.

Some more details of the software are provided below as implemented in an alternate embodiment of a cluster control box as implemented in FIG. 4A.

One important software program incorporated in the present invention is the diagnostic flash card that is selectively installed in the control box. Picture one of the elements of the program, such as the data from the cameras streaming images to the microprocessor, the stream being intercepted by the diagnostic program. If a special event is detected, such as a fire the software has the ability to understand what it sees and then can relay the information to the first responder flash card program.

The above example is only one component that will be written into the diagnostic discipline that will make up this most important program.

The functions in of the diagnostic flash card 420:

Call up all components and defaults to discover any faults. If any are found it will report the malfunction to the traffic command center by wireless network 215/217, The center then corrects and allows the program to continue the next movement.

The program analyzes data at the intersection and directs a command to the standard operating flash card that is programmed to operate display panels that are lighted to have red-yellow-green-arrows-street signs and have a written sequence for timing out the phases of the intersection. Street signs are a permanent command on the display. The program continuously monitors the ongoing actions.

The next part of this diagnostic flash card will through the data streaming is to recognize the need for first response. When the data is deciphered and it sees an accident-civil unrest-fire-a person signaling there is a problem in the area, the written program will call out the first response team. The program generates commands, the flash card program memory will have different forms of response equipment that the Police and the Fire Departments will send to the address where the problem intersection exists.

A software component of the diagnostic flash card analyzes the data streaming to detect at the subject intersection events that concern the HOME LAND SECURITY bureau. It recognizes and direct the commands to implement the HOME LAND SECURITY flash card program to respond to how to control this problem and notify the bureau.

The next function the diagnostic flash card will be capable of either being a slave controller or the primary controller to integrate and time base coordination for the operations at grid signal intersections. The flow of this command will keep the data stream diagnostic up dates of all the controllers that are in the program. The flash card program will be written to recognize and direct the integration.

The hardware and software that has been designed work the same way for roadway signs with the MATRIX PROCESS design. The idea of this was to standardize the signal and sign systems.

The hardware and software have been explained. The flow chart shows and block drawings have been submitted. The unique MATRIX PROCESS has never been thought of as a fully integrated signal and informational intersection for traffic control with HOME LAND SECURITY as a MATRIX PROCESS BEFORE. and how extensive the size of the intersections are unlimited. The normal amount of phases that are eight phases in today's signal.

More software programs can be placed on the perm ant program flash cards. The MATRIX PROCESS can be made through multiple flash card programming can expand too many new commands.

Thus, the cluster 10 can be run using several modes of operation. A somewhat simple mode is shown in FIG. 5. In the mode shown in FIG. 5, after normal operation is started (step 300), the microprocessor checks whether it is required to run under a remote (authorative), normal (local) or first response control (steps 302, 304, 306 and an appropriate subroutine is then run (steps 303, 305, 307). If none of these controls are applicable, an error message is sent to the command center (step 308) and the microprocessor falls back on a default, preferably asynchronous mode in which it operates independently of any other of the other clusters.

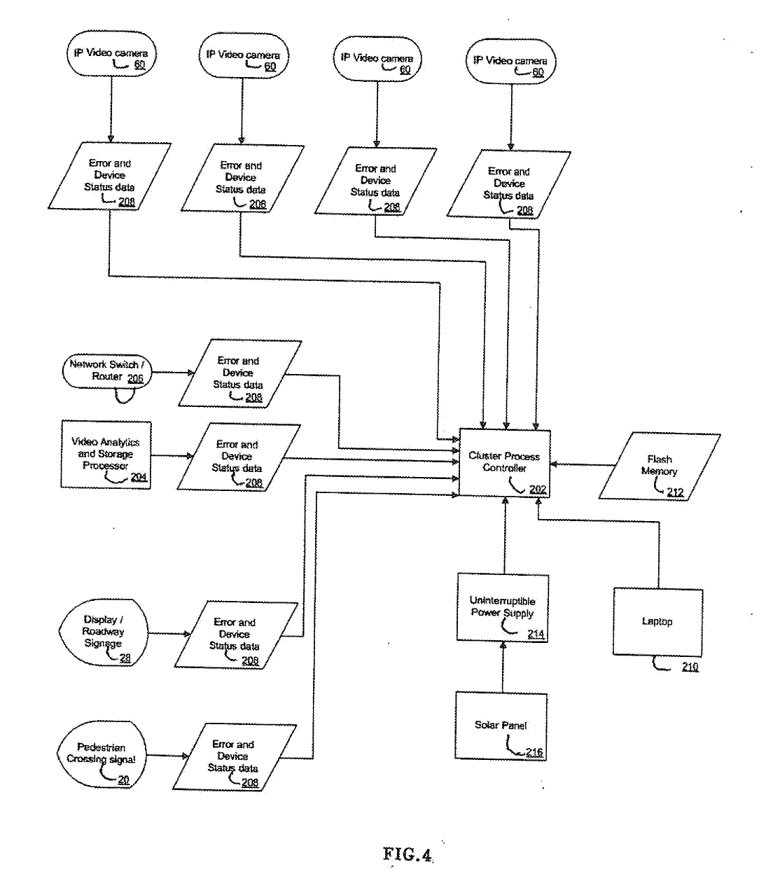

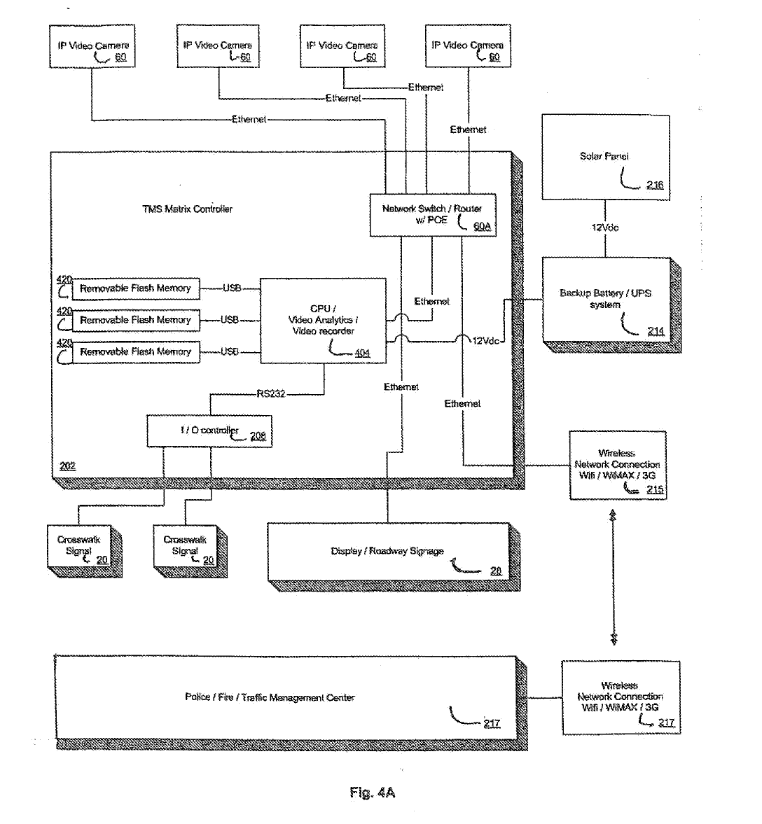

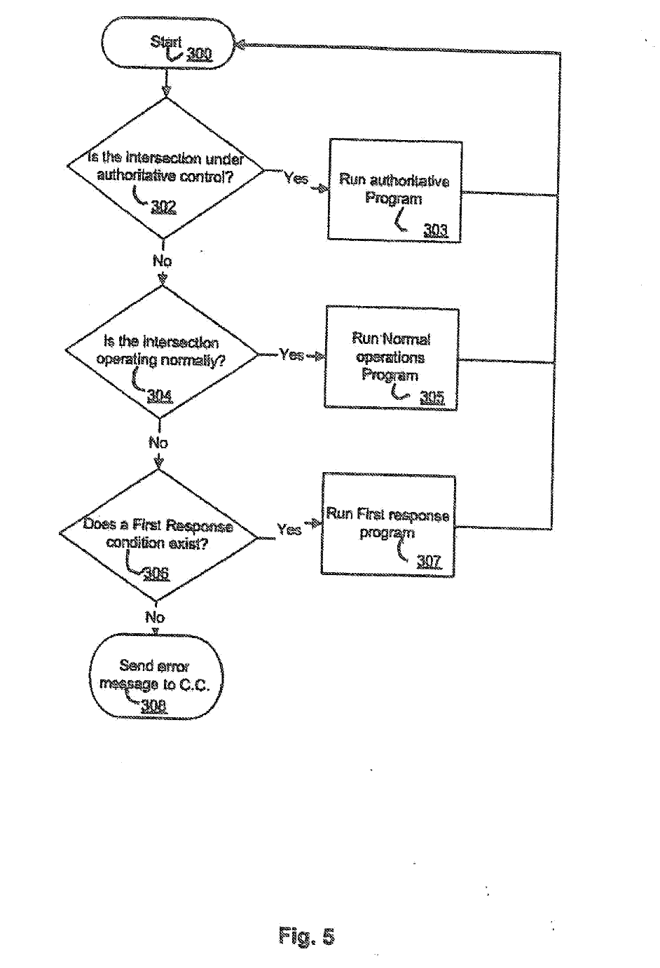

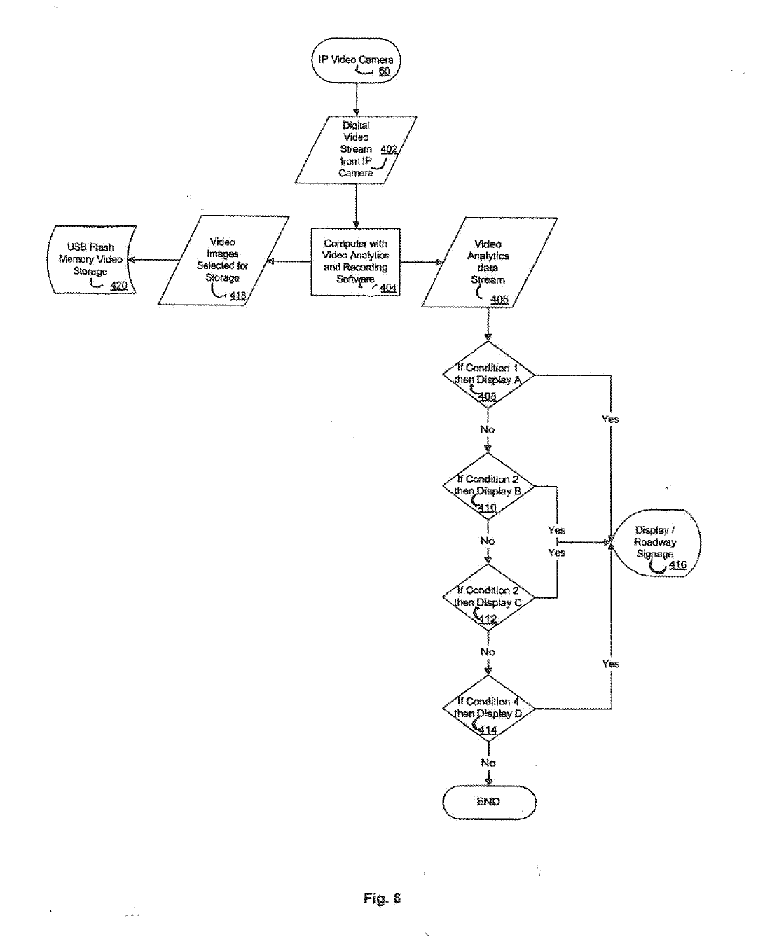

FIG. 6 shows a more complicated mode 400 in which images from at least one of the cameras 60 are streamed in step 402 to a video analytical module 404. The modules streams the video 406 to several other modules 408, 410, 412, 414, each module being configured to analyze the streamed video conditions 1, 2, 3, 4. Each of these conditions may depend on local events as well as conditions from other clusters of grid 100 and/or commands from other, remote centers. A set of rules is provided to generate a set of actions for activating each pedestrian sign 20 and display specific content on the display 20 (step 416). The video is also recorded for further analysis and/or archival purposes (steps 418, 420, in a flash or other type of memory).

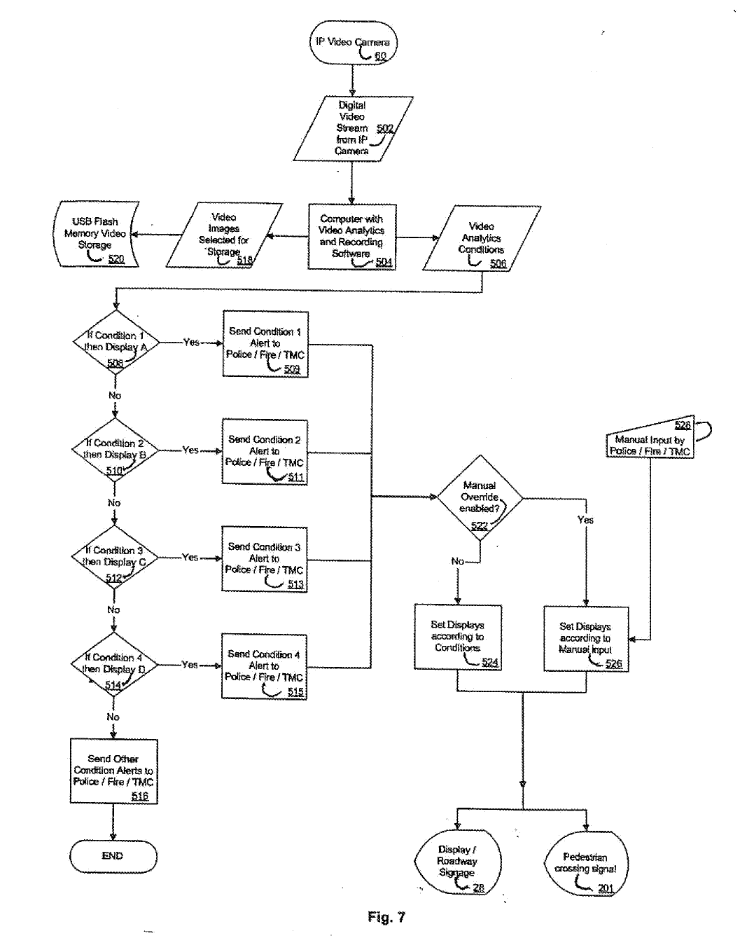

A somewhat more complicated mode is shown in FIG. 7. In this mode, in steps 502-516, images from cameras 60 are analyzed for various conditions, and, if necessary, appropriate information is sent to one or more of the remote centers, in addition to controlling or generating information for signs 20 and 28, The content and a control of signs 20 and 28 are further dependent on whether the cluster is under local (manual) control, or remote control through a remote component 528. Finally, the video information is stored in steps 518, 520.

The images from the video cameras 90 are analyzed by the respective modules to determine the presence of vehicles, their direction of motion, speed, etc. Moreover, other information, such as accidents, fires, etc., are also detected at the clusters, using various predetermined rules.

As described above information from each cluster is sent through the network 70 to the traffic command center 80, as well as the stations 86, and command 90. Each of these has assigned a certain security level which grants it rights to see at least some of the information from the clusters, and/or issue commands that, if necessary, interrupt the normal operation of the clusters and modify the same to allow emergency vehicles to go through, provide certain emergency information to the general public, and if necessary, view live pictures at the clusters.

This and other information is provided to the traffic command center which has its computer to interpret the information received from the equipment in the intersection and effectuate solution autonomously. Any situation that is deemed by the computer to by other that normally occurring will be analyzed and will be automatically corrected by the central computer without the interaction of the operator at the station. A Bypass manual command will be designed into the system which will allow Homeland Security personnel to operate the system during time of emergency at the local or worldwide level. Hardware and software can easily be part of planning and design as a new traffic management center. The software program will have the following functions written in its memory: control tech, dynastic tech, remote operating tech, and override command tech. The software will have automatic operating tasking. The information that will be received from the local field locations will be and the software will be able to send commands back to the local traffic signal locations that will be given will be fully automated by its program.

The control boxes can be implemented as cabinets with the respective hardware that is preferably rack mounted for easy installation and space saving application. Rack mounting is available for the additional hardware.

The cabinets are preferably NEMA 4x Stainless steel panels for the controller equipment. T

One of the advantages for this invention is that is solves the problem regarding the placement traffic signal equipment within proximity of power arms and high voltage lines, cable TV, telephone, high speed data lines. The new installation will not interfere with the mentioned facilities. The new mast arm arms can be designed shorter than that of the current equipment can allow. The TMS is mounted directly on the mast arm and only require road clearance of 16′-6″. The signal arms can be smaller, lighter, and safer by not having to withstand wind loads of heavier components attached to a conventional intersection of today.

The interconnection of the cluster components including the camera equipment, and pedestrian arms can be accomplished through smaller underground facilities. The majority of command operations will be sent through a fiber optic cable for sending and receiving command signals. Fiber optic cable is a good choice for this function for its small size, high speed data transfer, and the elimination of “cross talking”—the compromising of data due to electrical interference.

Preferably, the control cabinet and all the other equipment of the system is powered by a an uninterruptable power source that operate the system with reduced system operating amperage requirements and preferably incorporates one or more appropriately sized solar panels. The new TMS system has micro-components that use less power to operate and command the multi functional system. Environment consciousness is required in the world today to make it possible for the megilopises to have intersection safety, an informational center, and adapt to the existing roads that choke our cities.

In one embodiment, the cluster control boxes are made of aluminum, PVC, carbon fiber, or any other material to meet conditions of where it's to be installed. The size is dictated by applicable local laws, regulations and/or codes. The panel housing can be many different sizes depending on the requirements of each individual intersection. For example, a three lane intersection will be controlled from a sign that is only 1′.2″×20′.0″. Smaller panels house pedestrian information. Homeland security can display alert colors as a back lighted information center, while the signals can operate.

Details of one embodiment of the traffic signal can be seen in FIGS. 8=8E. In this embodiment, the display 28 extends along the length of arm 14 and is supported by a lattice structure made of bars, channels, beams or other similar members to form a strong and wind resistant arrangement. The video cameras 60, which may be CCTV type-cameras are disposed on top of the display. The display 28 may be controlled from control box 18, or in an alternate embodiment, the display 28 may have its own control box 28A.

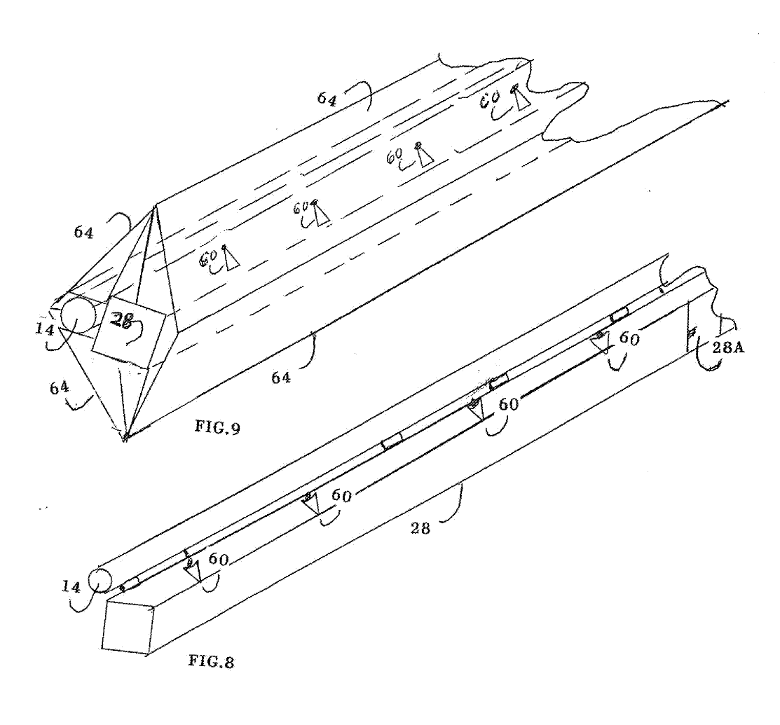

In one embodiment, shown in FIG. 9, protective panels 64 may be mounted on top and bottom of the display in a manner selected to deflect wind thereby insuring that a strong wind does not knock the display off or damage it. The panels may be made of a transparent material such as Lexon®.

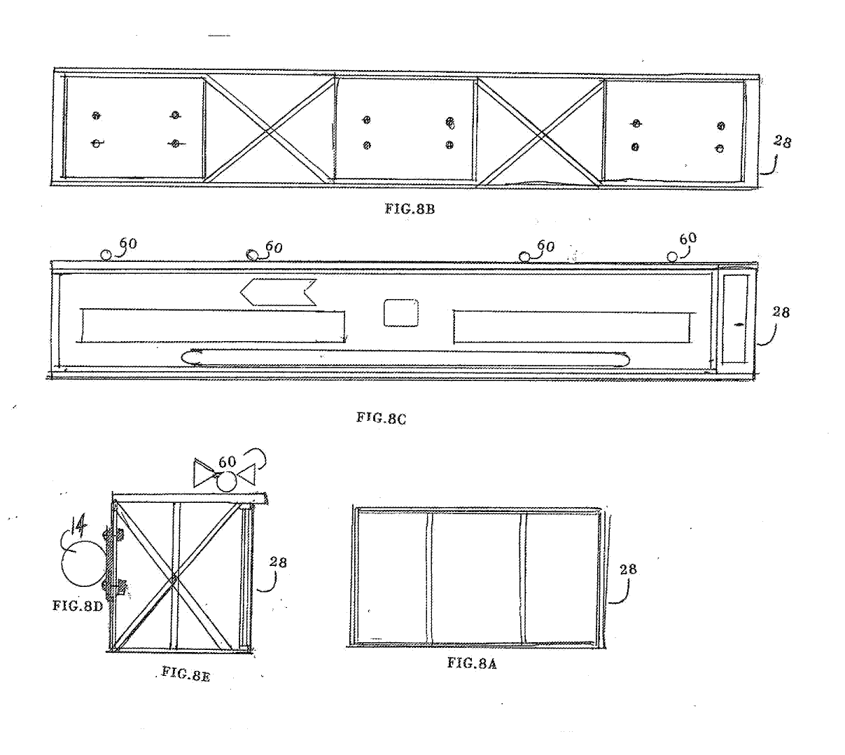

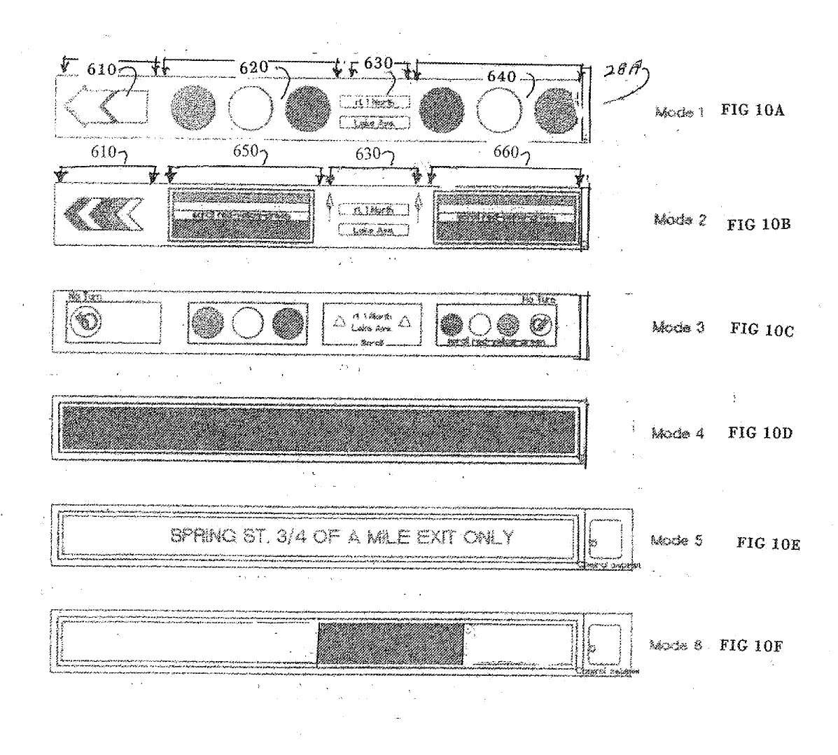

Preferably the display 28 is constructed and arranged so that it can be used in several different ways, as illustrated in FIGS. 10A-10F. In FIG. 10A, the display is section into four adjacent zones. Zones 620, 640 include three circular images simulating standard traffic lights that are alternatively, red, yellow or green. Zone 620 is dedicated for the left lane, and zone 640 for the right lane. Zone 610 shows a left turn signal and zone 630 provides other information, such as the name of the cross street. Each of the zones may have the same, or different background colors or patterns.

In FIG. 10B, the display is configured with zone 610—still a turn signal, zone 630—still a street name signal, but zones 650 and 660 are scrolling solid blocks or rectangles rather three adjacent lights. The rectangle are either red, yellow or green.

FIG. 10C shows another configuration with combined standard lights and turn lights.

FIG. 10D shows an emergency sign directing the drivers to take certain detours.

FIG. 10E is an expanded street/intersection sign.

FIG. 10F shows an alert from the home security command center.

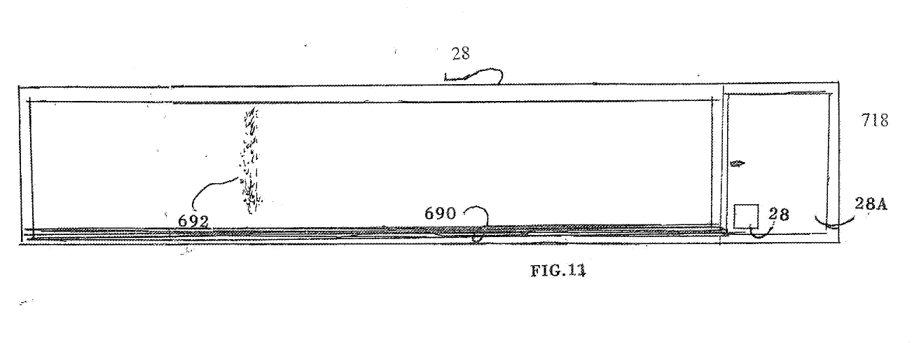

As previously mentioned, the display 28 could be made of an array or matrix of LED, LCD, Plasma or other type of display elements. In another embodiment, shown in FIG. 11, a bundle of optical fibers 690 extends from the control cabinet and along the arm 14 and are oriented so their tips are facing toward the driver. An image projector 692 at the box 28A generates the image which is then transmitted through the bundle 690 and ends up as one of the images shown in FIGS. 10A-10F.

To summarize, the operation of the lane signalization can scroll the colors of RED-YELLOW-GREEN and any arrows as commanded by the program. The display 28 acts as an information display board using LED, LCD, or PLASMA matrix color operation. In one embodiment, the controller panel 28A is be internally mounted in the display 289. The display can also display letters, numbers and images to inform motorists and pedestrians about emergencies and detour routes that have to be taken. By installing our advanced software program the system will have the total capacity of central and local automation that will benefit sprawling urban areas all over the world.

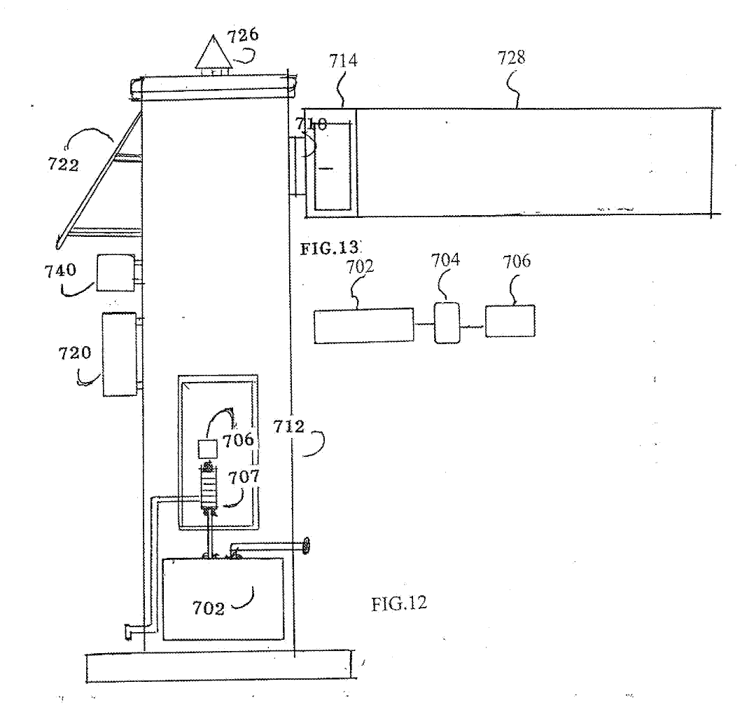

In one embodiment of the invention, a fuel cell 700 is used as a primary or back-up power source. As shown in FIG. 12, such as a cell 700 includes a hydrogen tank 702, a a hydrogen engine 704 that generates power for a DC generator 706. As illustrated in FIG. 13, advantageously, such a fuel cell can be incorporated into a traffic sign 710 including a a mast 712, a arm 714 supporting a display 728. The mast 712 further supports a solar panel 722, a control box 720, and an antenna 722. The hydrogen tank 702, the engine 704 and the dc generator 706 are disposed inside the mast 712 and feed a UPS 740. A hole 730 at the bottom of the mast 712 is used as an exhaust of the H20 that is the byproduct of the fuel cell.

Each traffic signal consists of a vertical post and an arm or mast supported as a cantilever at one on the post. Mounted on the post of one of the traffic signals of the cluster are the cabinet holding the controller, the power supply, the antennas and the solar panel. Alternatively, one or more of these components can be combined into a single cabinet that is mounted either on one of the posts, or at another location near the post. One or more of the posts also supports a screen for the pedestrians and pedestrian-operated pushbutton controls if any. The arm or mast is disposed at 16′-6″ from the ground and supports the main screen disposed in a display cabinet. The main screen is implemented as a LCD, plasma, LED, screen, optical fiber bundle or it can be implemented as a combination of these technologies. In windy areas, the screen may be surrounded with several sheets of plastic sized and shaped to limit and control the effect of the wind on the mast so that mast is not broken or damaged.

Also mounted on the traffic signal, preferably, on the mast are a plurality of video cameras. These cameras can be CCTV type cameras that are used to monitor what is happening within their designated zones. In one embodiment, two cameras are looking back and two cameras are looking forward from each mast. Moreover of each camera pair, one is set so that it looks at a distance while the other looks at closer objects. Moreover, at least some of the cameras are IR cameras.

The controller operating the cluster includes several modules implemented either as discrete elements or as software modules. The video signals from the cameras are fed to the controller modules which then use dedicated algorithms that recognize one or more of the following events at or near an intersection: a collision of one or more vehicles, a vehicle on fire, congestion, heavy pedestrian traffic, a pedestrian waving his arms to attract attention, etc. Depending on the particular event, the controller operates the signals of the cluster accordingly, and if necessary, alerts one or more of the remote stations (Police, Fire, Traffic Control, home land security) that there is some unusual event taking place, with a message that help may be needed, such as a police officer, an ambulance, a fire truck, etc. The pictures (and possibly sound from microphones set up at the cluster) transmitted to the respective facility will assist the appropriate dispatcher in determining what kind of equipment and/or personnel is needed.

In one embodiment of the invention, the cameras and controller cooperate to act as stop cameras that monitor if any motorist has entered an intersection when he is not supposed. A picture is then taken of the motorist's license plate, and a ticket is issued.

The controller receives power from the power supply that may include a battery, a solar cell, one or more AC sources, a UPS, etc. Preferably the controller runs on 12 VDC. As previously mentioned, the controller is software-controlled. An initial firmware is provided to control the main functions of the cluster. In addition, several ports, e.g., USB ports, are provided. These ports are used to provide a means of loading new temporary or permanent programs into the controller, using for example, USB flash memory cards.

General Benefits

The controller is operated by a software program that incorporates the functions for the automatic and local operations that can centralize information, and traffic systems all over the world.
Intersections in every configuration are built for traffic signal indication including safety and national security information and instructions.
Signals at intersections will be less costly to install.
Cities will be able to move more traffic faster through the intersections.
Command instructions from the central traffic management will be automated. The central traffic management computer will be able to diagnose and monitor any traffic problem and respond to any malfunction. Manual override should be used only in the case of an emergency.
Communication to the intersections from the TMC building can be carried out by Satellite and GPS locations through use of cell and microwave towers. Other means of command are Fiber Optic data lines and T-1 lines already in place.
Plans of a typical intersection have been included. The elevation-plan view, cross sections, and figures has been shown for the copy write and patent design for the project.
Power supplies will be solar operated to UPS batteries or local electrical UTY services. These services will be mounted on arms.
CCTV arms are used to alert the central traffic management system of the status and requirements of every intersection needs. The cameras will provide images of the approaches to the central traffic management computer to interpret and respond.

TMS panels will announce the control and vital information on a permanent ongoing basis. The TMS will display on the full screens and with central commands. They will be able to display a wide array of colors, shapes and images.

### Camera/Software Protocall

The following is an overview of the standard camera placements in a 4-way intersection and the function of the Software used to control a typical cluster 10.

A typical 4-approach intersection will consist of sixteen small cameras—two cameras per approach. Four cameras will be mounted on each display panels faced toward the on-coming traffic for each approach to the intersection. One camera will be positioned provide a close view of the intersection; the other camera will be positioned to provide a far view. Both cameras together will be able to provide a comprehensive view the entire approach of the intersection.

The Cameras will provide traffic information for the intersection. The Software uses the images provided by the cameras to determine vehicular traffic volume, rate of vehicular movement, and direction of vehicular traffic flow for each lane of traffic. The software also determines the same information for pedestrian traffic as well. The software then makes timing changes, create detours, and call for emergency vehicles assistance based on the information received from the cameras. The software can also to identify traffic infractions, such as running red lights or unauthorized turns, and record vehicles license plate for future law enforcement measures.

The intersection cameras combined with the software can provide revenue for owner. The software can be set up to provide information and images required to issue fines for stoplight infraction, unauthorized turns, and illegally parking and stopping.

The software takes the cameras information and process automatic commands to display information on the displays. It will continually observe and look for problems that can occur due to an accident and have the capability adjust traffic timing during times of heavy traffic volume, and diagnose malfunctions that may occur in the system's components.

The software can be programmed to operate as an individual signal intersection or a part of a grid network. The benefit of a grid network setup will be the ability for the system to effectuate complex timing sequences throughout the grid of individual traffic signals to insure optimal traffic efficiency. The software can provide emergency routing that may be required an emergency situation that may need a detour to flow traffic while an incident is cleared or corrected.

The software has the capacity to send out at real time information to other TMC throughout the world.

This method will eliminate the need for the present cycle design that cost time changes to limit a fast reaction in the program.

The next step in the software process in programming the control flash cards. These programs will operate as individual command programs that are the timing commands, first response operations, time base slave or master program, matrix display panels nomenclature, and home land security instructions that will take over the cameras and matrix display panels.

FLASH CARD PROGRAMS perform the following functions:

The red yellow green arrow that are set in a time cycle to call the phases to give the matrix display panels orders to The general twenty four seven operations flash card software program will contain normal commands of timing show the command to keep traffic and pedestrians flowing. When another program is desired to operate the intersection, another flash card can be created with other timings and placed into the master controller platform without any great delay by the field technician. The timing out of the intersection will be able to have clock settings for daylight saving and standard time, time out for each color or arrow and written street names, programmed for any differing time of the day and any length of time. This is normal operations.

The first response flash card software will be programmed to have different personal and equipment commands that will be dispatch to an intersection or the grid where the problem exists. First response, call up by its automatic command that will send immediate programmed signori to control the over response where the trouble has been detected. The rapid response has been programmed in its written software program. The next step in the software will notify the agencies and they can identify what other response may be necessary. The operator will have on his screen all the other se that may be used for further personal and equipment. The program will notify agencies at the same time with the problem at the sites. Police- Fire- TMC- and Home Land Security will be aware and react to what agency may handle the emergency best. Any agency mentioned can override the control the flash card and control the intersections in the grid.

In emergency situations the traffic command center, the emergency agencies and/or the Home Land Security agencies will have control of the flash card software program. This software has the ability to direct the grid intersections that can use all the matrix display panels to write commands that will notify the public where to detour and what word commands to flow traffic safely to other areas. The above software algorithms can be implemented as a flash card program wi. The primary and secondary flash cards are made to simplify the PROCESS and have cost effectiveness—low power factor—and a compact design of the entire system.

Numerous modifications may be made to the invention without departing from its scope as defined in the appended claims.

We claim:

1. A system for controlling vehicular and/or pedestrian traffic in a section of a city formed of intersecting streets comprising:
a plurality of clusters, each cluster being disposed at an intersection between two streets and including a plurality of traffic signs, each traffic sign including a mast extending vertically, a horizontal arm attached to the mast and extending over at least a portion of a street, a display attached to the arm, said display being formed of a matrix of light generating elements arranged and constructed to display one of images and text; and a cluster process controller controlling the images displayed on each display.

2. The system of claim 1 wherein said clusters operate in one of an autonomous mode in which each cluster functions independently and a coupled mode in which several clusters disposed within a portion of the city section, said several clusters being interconnected to exchange information and cooperating to act in unison to control traffic flow.

3. The system of claim 2 further comprising a traffic command center, wherein said clusters operate in a slave mode in which each cluster is operated by commands from the traffic command center.

4. The system of claim 1 wherein each display is formed of components including one of an LCD, LED, plasma, fiber optic and DLP elements.

5. The system of claim 1 wherein said cluster process controller generates one of instructions to drivers, street name, traffic information and traffic control signals.

6. The system of claim 1 further comprising a plurality of cameras monitoring one of pedestrian and vehicular traffic on the streets, said cameras providing images of said traffic to said cluster process controller, and wherein said cluster process controller generates said images based on said images.

7. The system of claim 6 wherein at least one street includes two lanes and wherein separate cameras are provided for each lane.

8. The system of claim 6 wherein some cameras provide information indicative of traffic near or within the intersection and other cameras provide information about traffic approaching the intersection.

9. The system of claim 1 further comprising a power supply for powering the display and the controller, said power supply being selected from one of a local power grid, a UPS with a battery back up, a solar panel and a hydrogen fuel cell.

10. A system for controlling traffic in a section of a city based on commands from a plurality of sources including a traffic command center, a fire/police station and a home security office comprising:
a plurality of clusters disposed at respective intersections, each cluster including a display displaying signs for controlling traffic and cameras monitoring traffic at the respective intersection, a cluster process controller, wherein the cluster process controllers send information to said sources indicative of traffic and other conditions at the respective intersection and the outer sources return commands in response, said commands being used by each said process controllers to operate said displays.

11. The system of claim 10 wherein each cluster includes several traffic signs disposed at several corners of the respective intersection, each traffic sign including a display controlled by said cluster process controller.

12. The system of claim 11 wherein each traffic sign includes a vertical mast and a horizontal arm attached to the mast and holding said display.

13. The system of claim 12 wherein said display extends at least partially over a street lane to control vehicular traffic.

14. The system of claim 13 wherein said each cluster includes pedestrian signs mounted on said mast to control pedestrian traffic at the intersection.
